(19) United States
(12) Patent Application Publication
(10) Pub. No.: US 2008/0264072 A1
(43) Pub. Date: Oct. 30, 2008

(54) LIQUEFIED GAS SUPPLY DEVICE AND METHOD

(76) Inventors: Shinji MIYOSHI, Tsukuba-shi (JP); Minoru Ino, Tsukuba-shi (JP); Kazuo Yokogi, Tsukuba-shi (JP)

Correspondence Address: AIR LIQUIDE;Intellectual Property, 2700 POST OAK BOULEVARD, SUITE 1800, HOUSTON, TX, 77056, US

(21) Appl. No.: 12/051,606

(22) Filed: Mar. 19, 2008

(30) Foreign Application Priority Data
Mar. 19, 2007 (JP) 2007-71034

(51) Int. Cl. F17C 9/02

(52) U.S. Cl. 62/48.1; 62/49.1; 62/51.1

(57) ABSTRACT

To provide a liquefied gas supply device and supply method that has good operability and a compact structure, and enables stable supply of large flow rates of liquefied gas while managing the consumption amount of liquefied gas promptly in real time. A liquefied gas supply device characterized by having container 1 filled with liquefied gas, load cell 2 for measuring the weight of container 1, halogen lamp unit 3 for heating container 1, and a gas transfer means to transfer gas in the gas-phase section of container1, and arranging halogen lamp unit 3, comprising halogen lamp heater 3a and space 3b for the lamp, and load cell 2 in an integrated structure at bottom section 1a of container 1.

### CROSS REFERENCE TO RELATED APPLICATIONS

The present application claims the benefit of Japanese Patent Application No. 2007-71034, filed Mar. 19, 2007, herein incorporated by reference in their entirety for all purposes.

### TECHNOLOGICAL FIELD

This invention pertains to a liquefied gas supply device and method to supply such gases as special material gases for semiconductor, represented by such gases, for example, as NH3, BCL3, CL2, SiH2CL2, Si2H6, HBr, HF, N2O, C3F8, SF6 and WF6.

### BACKGROUND TECHNOLOGY

Liquefied gases with low vapor pressure represented by such gases as NH3, BCL3, CL2, SiH2CL2, Si2H6, HF, C3F8, and WF6 are often used as special material gases used in semiconductor manufacturing processes. Such liquefied gases are stored in liquid form in a container with a specified capacity, and the gas at the gas-phase section is supplied to each process. When the gas at the gas-phase section of the container is discharged externally, the amount of liquefied gas corresponding to the portion of the decrease in pressure evaporates from liquid phase and supplied to the gas-phase section. Since much of the energy required for evaporation is taken from the liquid-phase gas remaining in the container, the temperature of the liquid lowers and the supply pressure of the gas-phase section lowers to soon cause a problem of disabling supply of the desired pressure unless a heating means is installed for the container.

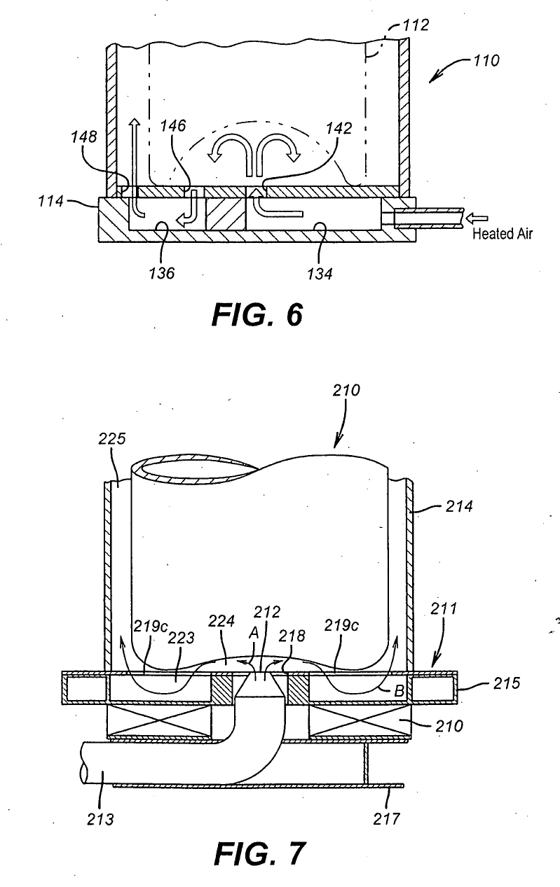

A method of adding heat to the container by using a heating means from the exterior surface of the container is used in general to secure evaporation volume of the liquefied gas. While such methods as a heating pad and hot-water jacket heater can be listed as the heating means, a method of supplying heat by blowing heating medium to the bottom of the container has been used as a simple heating means with excellent heat controllability for various applications recently. A heating device 110, for example, with a structure as shown in FIG. 6 has been proposed. Heating device 110 is equipped with a mounting base 114 that has space 1 and space 2 inside, and an air fan heater that supplies headed air in space 1 of the mounting base. The mounting base is characterized by having through-hole 142 connected to space 1 and through-hole 146 connected to space 2 in the mounting area, and through-hole 148 connected to space 2 outside the mounting area. In this composition, if gas container 112 is mounted on the mounting base, the heated air is blown onto the bottom of the gas container via the first through-hole from space 1, and the heat is conducted efficiently to the liquefied gas from the bottom of the gas container (refer to Patent published unexamined application (Hei 11) 1999-166697 for example).

A weigh-scale (hereinafter referred to as “load cell”) for measuring the weight of the liquefied gas is generally installed at the bottom of the container to manage the consumption or the amount of liquefied gas in the container that decreases with its consumption. A liquefied gas supply device having a composition as shown in FIG. 7, for example, has been proposed. More specifically, it is composed of installation base 211 to mount gas container 210, heating medium ejection nozzle 212 that ejects heating medium to the bottom of gas container 210, heating medium supply line 213 that supplies temperature controlled heating medium to said heating medium ejection nozzle 212, and container cover 214 comprising a semicylinder mounted on the top surface of installation base 211 in a manner of surrounding gas container 210, and installation base 211 is composed of gas container mounting section 215 that supports that bottom of gas container 210, load cell 216, which is a means to measure the weight, that is installed in a manner to support the circumferential section of gas container mounting s section 215, and base section 217 that is located at the lower part of said load cell 216 and to be installed on such surfaces as the floor. Heating medium supply line 213 runs horizontally into base section 217, is bent upwards at midway, runs up inside load cell 216, and is inserted into through-hole 218 at the center of gas container mounting section 215. The heating medium ejected at high speed from said heating medium ejection nozzle 212 towards the bottom of the gas container heats or cools the bottom of gas container 210, then flows to hollow section 223 through the inner circumference of slit 219c from space 224 between the bottom surface of the gas container and upper surface of the installation base, and then discharged to space 25 at the inner circumference of container cover 214 through the outer circumference of slit 219c (refer to Patent published unexamined application 2003-227597 for example).

### PROBLEMS TO BE RESOLVED BY INVENTION

The following problems could occur, however, with the aforementioned liquefied gas supply devices.
1. When the load cell and a unit for supplying the heating medium are installed in the small area at the bottom of the container, not only the structure of the bottom of the container becomes complicated but the height from the floor to the container mounting base becomes high, which causes difficulty in workability in such occasions as mounting and removing the container.
2. Since merely blowing the heating medium (e.g., air, nitrogen (N2) and water) has low thermal efficiency from the heating medium to container (small heat conduction coefficient at external wall boundary membrane), it is not possible to efficiently conduct thermal energy to the container. Therefore, it becomes necessary to apply unnecessary and excessive thermal energy, that is, to blow high-temperature heating medium, which results in conduction of thermal energy of the heating medium to the load cell and causes malfunctioning of the load cell, which leads to a problem of disabling accurate weight control. Excessive thermal energy is also undesirable from the viewpoint of energy conservation.
3. If the thermal load applied to the load cell is considered in the conventional technology, the thermal energy applied to the container will naturally be limited, and thus the volume of gas flow to be vaporized has been limited (detailed explanation will be given later). As a result, in cases where the affect of supply pressure due to lowering of the gas-phase temperature can not be ignored, such as in a process that requires a large flow rate, or when using low vapor pressure liquefied gases, the number of containers has to be increased, leading to higher cost.

The objective of this invention is to provide a liquefied gas supply device and supply method that has good operability and a compact structure, and enables stable supply of a large flow rate of liquefied gas while promptly managing the consumption of the liquefied gas in real time.

The inventors of this invention reached completion of this invention after accumulation of dedicated research to resolve the aforementioned problems, and discovered that it is possible to realize the aforementioned objective by the liquefied gas supply device and supply method as described below.

This invention is a liquefied gas supply device characterized by having a container filled with liquefied gas, a weight measuring means to measure the weight of said container, a heating means to heat said container, and a gas transfer means to transfer the gas in the gas-phase section of said container, and having said heating means and weight measuring means composed of a heating medium that radiates heat or light, and a space to allocate said heating medium as an integrated unit at the bottom of said container filled with liquefied gas.

This invention is also a liquefied gas supply method that transfers gas in the gas-phase section of said container from said container filled with liquefied gas, and characterized by managing the amount of remaining and consumed liquefied gas by measuring the weight of said container, and controlling supply pressure of the liquefied gas by heating the bottom of aforementioned container using a heating medium that radiates heat or light and installed as an integrated unit with aforementioned weight measuring means at the bottom of aforementioned container.

Since a liquefied gas supply device plays an important role in such processes as, for example, the semiconductor manufacturing process, a consistent supply of liquefied gas is requested, and securing stability of the pressure of the supply source and comprehension of the supply status of the supply source is necessary. Moreover, a liquefied gas supply device that is compact and has high operability, along with the aforementioned functions is demanded. This invention makes it possible to provide a liquefied gas supply device that has a compact structure and can supply, with excellent responsiveness and efficiency, the thermal energy of the heating medium to the container by using a heating medium that radiates heat or light as the heating means, and integrating the load cell that manages the weight of the liquefied gas container and the heating means that maintains the supply pressure. As the result, it becomes possible to consistently supply a greater flow rate compared to conventional technologies. Moreover, by realizing a compact structure, it is possible to keep the height of mounting the container from the floor low, which results in improvement of workability.

This invention is also characterized by using a heating medium that radiates heat or light as the heating means. By making it easy to integrate it with the load cell as described above due to the versatility of its form and structure, which contributes to making the device compact, and making it possible to interrupt thermal transfer to the load cell with a simple means, which will be described later, it became possible to remove the negative effect resulting from the integration, which has been a conventional problem, and compose a liquefied gas supply device and supply method with excellent functions.

This invention is the aforementioned liquefied gas supply device characterized by having a space where a cooling medium is filled or flowing, between the aforementioned weight-measuring means and the aforementioned heating medium.

As described above, it became possible to realize integration of the load cell and heating means in a compact structure by using a heating medium that employs radiation energy. At the same time, this invention verified that it is possible to structure the device relatively easily even in cases of securing a space for filling or flowing a cooling medium between the weight-measuring means and heating medium, and realized thermal interruption to the periphery of the heating medium, which has been difficult with other conventional means. That is, by having a space for filling or flowing a cooling medium and making the structure compact, it has become possible to provide a gas supply device in which the load cell and heating medium are integrated without the thermal energy radiated from the heating medium negatively affecting the load cell since it is structurally and thermally isolated and also has a cooling function.

This invention is the above mentioned liquefied gas supply device characterized by having aforementioned weight measuring means and aforementioned heating medium, each positioned at a fixed constant distance from the installation surface at the bottom of aforementioned container, and arranged in a near-coplanar manner.

With the transfer of the liquefied gas, the amount of gas transferred from the gas-phase section is supplemented from the liquid-phase, and the energy applied to the bottom of the container filled with liquefied gas corresponds to the amount of transpiration energy to the gas-phase section. At this time, with the decrease in the amount of liquefied gas in liquid-phase, the mounting surface of the container moves slightly, via the weight measuring means, from the installation surface of the liquefied gas supply device. This invention is characterized by positioning the weight measuring means and the heating means at certain fixed distance from the mounting surface of the container, and controlling the energy added solely by the heating medium. This enables prompt and stable control. Moreover, it is desirable that the mounting surface of the container is close to the aforementioned installation surface for replacing and maintaining the heavy container, and if multiple functions are added to the installation base, higher elevation of the mounting surface is unavoidable. This invention makes it possible to compose a liquefied gas supply device or supply method with excellent functions by keeping the elevation low and enabling a compact structure with good operability by arranging the weight measuring means and heating medium in a near-coplanar manner.

This invention is the aforementioned liquefied gas supply device characterized by having a means to automatically control the output of aforementioned heating medium as means to measure the pressure of the gas-phase section in aforementioned container, and maintain said pressure at a certain level.

In case a large volume of liquefied gas is consumed as processing gas used for semiconductors, an amount liquefied gas vaporized in the container that corresponds to the amount of liquefied gas transferred from the container becomes necessary. Since lowering of vaporization represents lowering of the pressure of the gas-phase section in the container, it is desirable to monitor this. A heating medium that utilizes radiation energy allows changing the amount of radiation energy extremely quickly compared to other heating means due to its output control since it allows making the thermal capacity of the heating side small. In case of attempting thermal isolation of the heating medium from its surrounding as stated above in particular, it allows such function to be higher. This invention uses such thermal sources as means to supplement the aforementioned vaporized amount of liquefied gas, and makes it possible to provide an excellent liquefied gas supply device with consistent supply even if a large flow rate of liquefied gas is necessary by automatically controlling the output of the heating medium in accordance with the amount of liquefied gas supplied.

This invention is the aforementioned liquefied gas supply device characterized by using a halogen lamp as the aforementioned heating means.

As the aforementioned heating medium that uses radiation energy, electric heaters, and heating elements using heated water can be considered. Halogen lamp is suitable as a thermal source that requires on-demand heating control since there is no thermal inertia caused by the thermal capacity of the heating side compared to electric heaters and heating with heated water. This invention employs heating using a halogen heater as a means to externally supplement a large amount of evaporative latent heat that accompanies the supply of liquefied gas, and by using this thermal source, it is possible to consistently supply liquefied gas even if a large flow rate is required and improve the thermal efficiency by over twofold compared to such conventional methods as the jacket heater. Therefore, it became possible to provide an excellent liquefied gas supply device with stable supply of liquefied gas.

### EFFECT OF INVENTION

As stated above, with this invention it is possible to provide a liquefied gas supply device and supply method that has good operability and a compact structure, and enables stable supply of a large flow rate of liquefied gas while promptly managing the consumption of the liquefied gas in real time, by arranging a heating means composed of a heating medium that radiates heat or light and installed as an integrated unit with a weight measuring means at the bottom of the container.

### OPTIMAL CONFIGURATION FOR IMPLEMENTING INVENTION

Configurations of implementing this invention are described below with figures. The liquefied gas supply device (hereinafter referred to as “this device”) pertaining to this invention is characterized by having a container filled with liquefied gas, a weight measuring means to measure the weight of the container, a heating means to heat the container, and a gas transfer means to transfer the gas in the gas-phase section of the container, and having a heating means and weight measuring means composed of a heating medium that radiates heat or light, and a space to allocate the heating medium and a weight measuring means as an integrated unit at the bottom of the container.

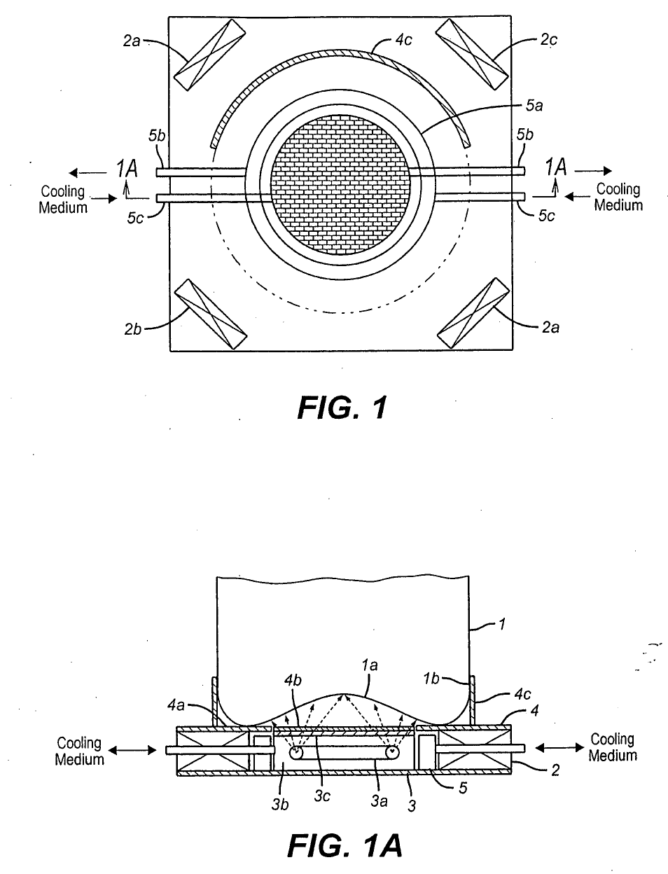

FIG. 1 is an outline diagram that exemplifies this device. In this device, container 1 filled with liquefied gas is mounted in a state in which its bottom section 1a and side section 1b are supported by mounting base 4. Multiple cell parts 2a, 2b . . . are arranged in a near-equidistant manner at the periphery of the backside of mounting surface 4a of installation base 4, and load cell 2 (corresponding to weight measuring means) that measures the weight of container 1 is installed. In the space at its center, halogen lamp unit 3 (corresponds to heating means; hereinafter referred to as “lamp unit”) is located in a near-coplanar location to load cell 2, in an integrated form with load cell 2, and space 5 in which a cooling medium is filled or flowing is secured between load cell 2 and lamp unit 3. Light outtake section 4b in a hollowed-out form, corresponding to bottom section 1a to which heat or light is radiated, is located on mounting surface 4a. Halogen lamp heater 3a (corresponds to heating medium; hereinafter referred to as “lamp”) is located at the center of lamp unit 3, space 3b is secured around it, and transmitting glass 3c that allows light passage is located at the surface that touches light outtake section 4b. Light emitted from lamp 3a is radiated to bottom section 1a via light outtake section 4b and transmitting glass 3c to heat container 1, and thus heating the liquefied gas filled inside.

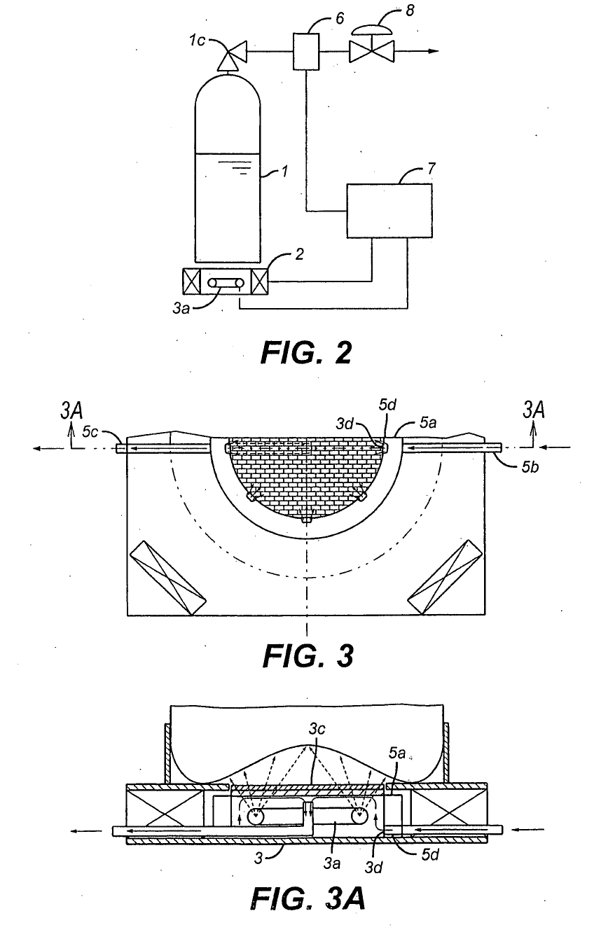

This device is connected via valve 1c as shown in FIG. 2, and has means 6 (pressure sensor) to measure the pressure of the gas-phase section in the container and means 7 (AVP controller) that controls the output of lamp 3a to maintain said pressure at a constant level. Special material gas maintained at a constant condition is vaporized in container 1 and then supplied consistently to various devices, for example, in a semiconductor manufacturing process via valve 1c and pressure regulator 8 (corresponds to gas transfer means). The supply flow rate can be adjusted with a flow controller at the processing device side. It is also possible to manage the weight of container 1 by inputting load cell 2 output to AVP controller 7. Details will be described later.

The pressure inside container 1 is controlled by AVP controller 7 based on pressure sensor 6 output. More specifically, by comparing the preset value (corresponds to set liquid temperature derived from the correlation of vapor pressure and temperature) and output of pressure sensor 6 (corresponds to liquid temperature obtained from the correlation of vapor pressure and temperature), extremely stable control without overshooting becomes possible due, for example, to PID control at AVP (all vapor phase).

Liquefied gases with low vapor pressure represented by such gases as NH3, BCL3, CL2, SiH2CL2, Si2H6, HF, C3F8, and WF6 are filled in container 1. The dimensions of container 1 depend on the scale of semiconductor manufacturing process used, but in this invention, small container of several to several tens of liters or medium size pressure-resistant container of several tens to several hundreds of liters can be considered. More specifically, in the case of ammonia for example, a system that supplies aforementioned liquefied gas with liquid temperature of approximately 13˜15° C. at approximately 10˜20 L/min (SLM) from a 47 L capacity container with internal pressure of approximately 0.55˜0.65 MPaG can be considered. It is also possible to use this device not only for small to medium pressure-resistant containers of several to several tens of liters, but also for bulk supply systems that use large containers such as a ton-container.

On one side of installation base 4, that forms mounting surface 4a where bottom section 1a is mounted, aforementioned light outtake section 4b and guide 4c for setting container 1 at a specified position of a part of mounting surface 4a are attached. Since this guide 4b is freely exchangeable adapter to suit the container size (diameter), it firmly secures the container in place.

In this device, load cell 2 is located around the periphery of the backside of 5 mounting surface 4a and lamp unit 3 at the center, so that load cell 2 and lamp unit 3 are at a constant distance from mounting surface 4a as shown in FIG. 1, and are positioned in a near-coplanar manner as shown in A-A cross section in FIG. 1. Conventionally, when adding a heating function to the load cell, or adding a weight measuring function to the heating unit, it has been unavoidable to adopt an overlaying structure at the mounting surface of the container. With this device, however, it is possible to arrange load cell 2 and lamp unit 3 in a near-coplanar manner by employing lamp unit 3 that is made compact due to such heating medium as lamp 3a. This arrangement makes it possible to realize a compact structure with low elevation and good operability even when multiple functions are added to the installation base.

Load cell 2 measures the weight of container 1 via mounting surface 4a, and monitors the consumption and remaining amounts of liquefied gas filled in container 1. While there is nor restriction as to its type as long as it can accurately sense the weight of container 1 applied to mounting surface 4a, FIG. 1 shows a type that has four cell parts 2a˜2d arranged in a near-equidistant manner at four corners of mounting surface 4a. The weight pressure at each cell part is output and converted by a strain gauge or such displacements as a diaphragm, and transmitted to AVP controller 7. It is also possible to use a cell part that matches the shape of the bottom of container 1, such, for example, as a ring-shaped or partially semicircular shaped cell, and one such cell or a combination of multiple such cells may be used. It is also possible to use four independent load cells located at 2a˜2d and measure the weight from the total weight.

Lamp unit 3 has transmitting glass 3c on one side and lamp 3a at the center of its internal space. Space 3b has a structure that can be purged by air or inert gas (such as N2) to prevent temperature rise. As for transmitting glass 3c, a material that has high light-transmitting ratio for such rays as infrared is desirable. Specifically, quartz is desirable, and also borosilicate glass that is inexpensive and has high light-transmitting ratio is desirable.

In this invention, a halogen lamp (lamp 3a) that radiates such light as infrared is used as a heating medium. While it is possible to use such means as a carbon heater instead, halogen lamp is more desirable since it has high thermal density and can efficiently heat bottom section 1a of container 1. As lamp 3a uses the light radiated as its thermal source, heat is applied only when the light is applied, and thermal energy is applied almost instantly when the switch is turned on. It, therefore, has faster response time compared to conventional heating methods and it is possible to prevent overshooting by using a control method described later. Moreover, since lamp 3 does not contact container 1, there is no heat retention effect by the heater, and is characterized by its extremely fast response time. Furthermore, since it is possible to arbitrarily use multiple numbers of heaters with specified capacity, it will be possible to conduct fine temperature control by arbitrarily controlling the number of heaters and each heater's output. In terms of safety consideration, non-contact lamp 3 has the advantage over the conventional types of thermal sources that directly contact the container. It is also more inexpensive and provides easier handling than the conventional heaters.

In order to radiate the light to the target surface efficiently, it is desirable to position a reflector (not shown in figure) at the opposite of transmitting glass 3c of lamp 3a or lamp unit 3. By converging the light radiated from lamp 3a with the reflector to prevent bleeding of the light outside, it is possible to efficiently radiate the radiation energy to bottom section 1a of container 1 and further improve thermal efficiency. In other words, since lamp 3a is not in contact with container 1, the thermal efficiency can further be improved by converging the light leaking from the gaps to the target area of bottom section 1a using the reflector. While it is possible to place the reflector to cover lamp 3a and the entire radiation surface, or mount a specified curved reflector at the opposite side of lamp 3a and transmitting glass 3c, it is also possible to direct the radiation towards the target area by selecting lamp 3a applied with a reflective coating. While there is no restriction as to the type of the reflector as long as it reflects visible light and infrared ray, it is desirable to use those with highly reflective coating such as gold and aluminum on the surface of metal or resin material.

### Supply of Cooling Medium for This Device

This device is characterized by having space 5 in which a cooling medium is filled or flowing, between load cell 3 and lamp 3a. By having space 5 and making the structure compact, it has become possible to eliminate negative effect to the load cell performance by the thermal energy radiated from the heating medium, due to thermal isolation and by having a cooling function. More specifically, as shown in FIG. 1, cooling pipe 5a for the cooling medium is installed in space 5. This cooling pipe 5a has supply port 5b for sending in cooling water or air and discharge port 5c, and has a structure to remove the heat from lamp unit 3 so that it is not conducted to the load cell.

As to the supply method of the cooling medium, it is not limited to the method shown in FIG. 1, and it is also possible to use a configuration as shown in FIG. 3 with supply port 5b and discharge port 5c at one location each. That is, first a cooling medium (cooling water or air) is supplied to cooling pipe 5a that contacts the outer periphery of lamp unit 3. Opening 5a are made at equal distance in the circumference direction at the bottom of cooling pipe 5a, and opening 3d are also made on lamp unit 3 at the same locations. Said cooling medium flows from cooling pipe 5a into the interior of lamp unit 3, cools the surface of lamp 3a and then transmitting glass 3c, and is finally discharged from the discharge port at the center of lamp unit 3 outside. In this case, since it is forcibly discharged outside, it is desirable to equip such means as a pump or vacuum generator (not shown in figure). To prevent the glass in lamp unit 3 from breaking, a protective metal mesh (not shown in figure) is applied over the glass surface.

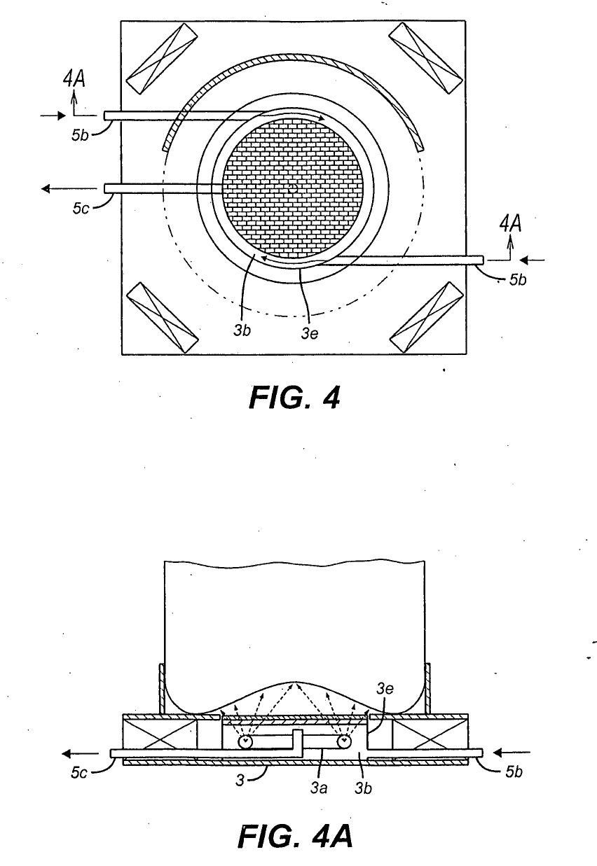

It is also possible, without using cooling pipe 5a, as shown in FIG. 4, to make direct use of space 3b and its side wall 3e of lamp unit 3 and make supply port 5b at two locations not at the center of lamp unit 3 but along side wall 3e. That is, when the cooling medium (air) is supplied from supply port 5b, the cooling medium flows into space 3b and at the same time moves along side wall 3e, cools side wall 3e, surface of lamp 3a, and transmitting glass 3c respectively, and is finally discharged outside from the discharge port at the center of lamp 3a. By supplying it from two locations, it is possible to cool the entire circumference of side wall 3e of pseudo-space 3b. If two locations are insufficient, it is possible to achieve further efficient thermal isolation by adding supply port 5b with the same structure. In this case, the same condition as the above is desirable as to the forcible discharge and protective metal mesh.

### Effect of Supplying Cooling Medium in This Device

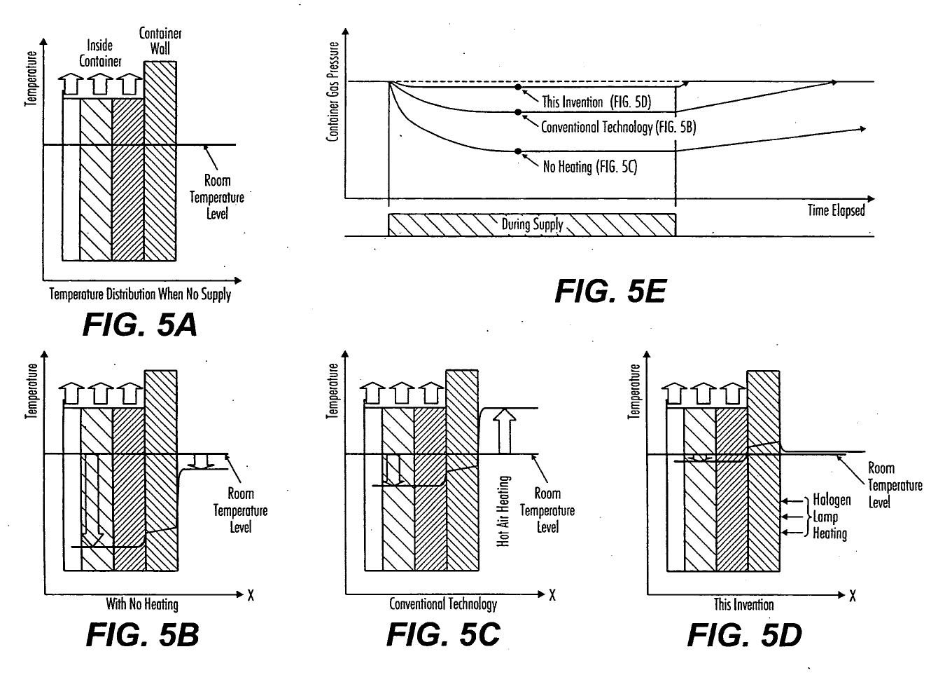

This device enables measuring the weight of the container filled with liquefied gas, and at the same time, realizes unprecedented excellent functions by supplying a cooling medium to the space between the load cell and heating medium, when controlling the supply pressure of the liquefied gas by heating the container. The state of liquid temperature distribution at the side wall of the container and inside the container, as well as the temporal change in the pressure of the gas-phase section in the liquefied gas container, is explained below using FIG. 5 (A)˜(E).
A. A state when liquefied gas is not supplied is shown in FIG. 5 (A). The liquid temperature at both the side wall and inside of the container is constant at room temperature level.
B. A state when liquefied gas is supplied without heating is shown in FIG. 5 (B). When the gas at the container's gas-phase section is discharged outwards, the amount of gas corresponding to it vaporizes from liquid phase. Since the energy required for this vaporization is taken from the liquid-phase gas remaining in the container, the liquid temperature drops drastically and eventually causes the supply pressure of the gas-phase section to drop (see FIG. 5 (E)(b)).
C. A state when a heating method using the conventional technology (hot air) is used is shown in FIG. 5 (C). Since the thermal conduction efficiency to the container using hot air is low, it is necessary to blow excessive thermal energy, that is high-temperature hot air, to supply the energy required for vaporization from the liquid-phase gas in the container, and as a result, the excessive thermal energy is conducted to the load cell to cause malfunctioning of the load cell, and accurate weight control is hampered (see FIG. 5 (E)(c)).
D. A state when thermal isolation between lamp 3a and load cell 2 is conducted using a cooling medium, as in this device, is shown in FIG. 5 (D). Since malfunctioning of the load cell is eliminated, and accurate weight control and supply of adequate thermal energy are realized, the liquid-phase temperature of container 1 is adequate and the supply pressure at the gas-phase section is also controlled adequately (see FIG. 5 (E).

### Control Method Using AVP Controller

With this invention, as shown in FIG. 2, it is possible to provide an excellent liquefied gas supply device and supply method for special material gases, by using load cell 2, lamp 3a, and AVP controller 5. Here, the correlation between the vapor pressure and temperature of the liquefied gas (PT correlation equation) is pre-input in the AVP, which is a control system that enables on-demand heating due to PID control between the liquid temperature obtained from the saturated vapor pressure of the liquefied gas in the container and the set liquid temperature.

That is, it is possible to assess, from the pressure of liquefied gas in the container's gas-phase section, whether a sufficient amount of vaporization corresponding to the transferred amount of liquefied gas supplied from container 1 is supplemented from the liquid-phase gas, and it is desirable to monitor this. Since lamp 3a that uses radiation energy can lower the thermal capacity of the heating side, it is possible to increase or decrease the radiation energy quickly by its output control.

More specifically, output from lamp 3a is controlled so that the pressure (liquid temperature) is constantly at a set level from comparison with the output of pressure sensor 6 that was input at the time of operation at AVP controller 5. It is also possible to input load cell output to calculate the consumed and remaining amount of liquefied gas to predict replacement time and reduce output in cases of warnings. That is, it is possible to finely adjust the output of lamp 3a so that the heating energy is reduced in accordance with the decrease in the liquefied gas remaining in the container.

As to pressure sensor 6 used here, while its type is not restricted as long as it is pressure resistant, from the aspect of measuring accuracy, such sensors as the diaphragm type, piezo type, or semiconductor type can be selected depending on the use.

By employing the structures and control methods stated above, this invention allows conduction of optical energy (radiant heat) radiated from the halogen lamp directly to the bottom of the container, and realizes drastically improved thermal efficiency from the conventional methods to provide stable supply of larger flow rate than the conventional methods as a result.

### INDUSTRIAL APPLICABILITY

Although the description above mainly deals with the supply device and supply method of special material gases for semiconductor used in semiconductor or FPD manufacturing processes, this invention is not limited to liquefied material gas for electronics, but can be used for any process in which a solid substance (or liquefied substance) is thermally vaporized and used, the weight of the container holding the substance is managed, and at the same time its consumption amount is controlled by controlling the heating temperature.

### BRIEF EXPLANATION OF FIGURES

[FIG. 1] Outline diagram that shows liquefied gas supply device pertaining to this invention.

[FIG. 2] Explanatory diagram that shows control method by AVP in liquefied gas supply device pertaining to this invention

[FIG. 3] Explanatory diagram that shows supply method of other cooling medium in liquefied gas supply device pertaining to this invention

[FIG. 4] Explanatory diagram that shows supply method of other cooling medium in liquefied gas supply device pertaining to this invention

[FIG. 5] Explanatory diagram that shows comparison of liquefied gas supply method pertaining to this invention and other supply methods

[FIG. 6] Outline diagram that shows heating device for gas containers pertaining to conventional technologies

[FIG. 7] Outline diagram that shows gas supply devices pertaining to conventional technologies

### EXPLANATION OF CODES

1 Container

1a Bottom section

1b Side section

1c Valve

2 Load cell

2a, 2b, 2c, 2d Cell parts

3 Halogen lamp unit (lamp unit)

3a Halogen lamp heater (lamp)

3b Space

3c Transmitting glass

4 Installation base

4a Mounting surface

4b Light outtake section

4c Guide

5 Space

5a Cooling pipe

5b Supply port

5c Discharge port

6 Pressure measuring means (pressure sensor)

7 Control means (AVP controller)

8 Pressure regulator

What is claimed is:

1. A liquefied gas supply device characterized by having a container filled with liquefied gas, a weight measuring means to measure the weight of said container, a heating means to heat said container, and a gas transfer means to transfer the gas in the gas-phase section of said container, and having said heating means and weight measuring means composed of a heating medium that radiates heat or light, and a space to allocate said heating medium as an integrated unit at the bottom of said container filled with liquefied gas.

2. The liquefied gas supply device of claim 1, characterized by having a space for filling in or distributing a cooling medium between aforementioned weight measuring means and aforementioned heating medium.

3. The liquefied gas supply device of claim 1, characterized by having aforementioned weight measuring means and aforementioned heating medium, each positioned at a fixed constant distance from the installation surface at the bottom of aforementioned container, and arranged in a near-coplanar manner.

4. The liquefied gas supply device of claim 1, characterized by having a means to automatically control the output of aforementioned heating medium as means to measure the pressure of the gas-phase section in aforementioned container, and maintain said pressure at a certain level.

5. The liquefied gas supply device of claim 1, characterized by using a halogen lamp as aforementioned heating medium.

6. A liquefied gas supply system that transfers gas in the gas-phase section of a container from said container filled with liquefied gas, and characterized by managing the amount of remaining and consumed liquefied gas by measuring the weight of said container, and controlling supply pressure of the liquefied gas by heating the bottom of aforementioned container using a heating medium that radiates heat or light and installed as an integrated unit with aforementioned weight measuring means at the bottom of aforementioned container.
